(19) United States
(12) Patent Application Publication
(10) Pub. No.: US 2019/0373847 A1
(43) Pub. Date: Dec. 12, 2019

(54) LITTER FOR USE IN ANIMAL HUSBANDRY

(71) Applicant: Catural GmbH, Mannheim (DE)

(72) Inventor: Josef Immanuel EHRLER, Mannheim (DE)

(21) Appl. No.: 16/434,213

(22) Filed: Jun. 7, 2019

(30) Foreign Application Priority Data
Jun. 8, 2018 (EP) 18176781.5

(51) Int. Cl. A01K 1/015

(52) U.S. Cl. CPC A01K 1/0155; A01K 1/0154

(57) ABSTRACT

The present invention relates to a litter for use in animal husbandry, the use of the litter, and a method for producing a litter.

The present invention relates to a litter for use in animal husbandry, the use of the litter, and a method for producing a litter.

Litter is a material used in animal husbandry in order to cover the floor of stables and cages and absorb animal excretions. Organic and mineral materials used for litter are primarily inexpensive agricultural or industrial byproducts or cost-effective raw materials. Conventional and widely-used materials include straw, shavings from hardwoods (such as beech or aspen) and softwoods (such as pine and cedar), and minerals or clays.

Economical use of the litter is ensured if the litter layer, on moistening with animal bodily fluids, does not allow these fluids to seep through the entire layer, which would make it necessary to replace the entire said litter layer. In this case, the upper components that come into contact with the fluid stick together, thereby forming clumps or sheet-like soft chunks on top of the litter layer that can be removed from the litter layer as the uppermost layer with a litter scoop without affecting the underlying layers. Contamination by the bodily fluid is thus limited to a small area, while the remaining litter remains undamaged. This effect is achieved by means of the clump-forming properties of the litter itself.

Known ecological litter is usually composed of wood flours and gel-forming agents. Wood flours act as separating and binding agents in a litter, and gel-forming agents serve to absorb liquids and solidify lumps.

DE 601 14 237 describes a litter without gel-forming agents that comprises wood flour and cereal flour. Although such a litter shows extremely low adhesion, the products do not harden and thus show insufficient clump strength.

In contrast to this known litter, it is desirable to provide a litter that does not have the abovementioned disadvantageous characteristics.

The object of the present invention is therefore to provide a litter that allows clump formation with a high degree of clump strength, causes little sticking to animal hairs, and moreover shows a strong odor-binding action, and a method for producing such a litter.

This object is achieved by means of the embodiments characterized in the claims.

A first aspect of the invention relates to a litter for use in animal husbandry in the form of pressed granules having a particle size of 0.1 to 10 mm, consisting of 65 to 99.5 wt. % of cereal flour, 0.1 to 20 wt. % of a gel-forming agent selected from at least one component of the group consisting of guar gum flour, locust bean flour, tara gum flour, xanthan, gellan, karaya, alginate, agar, carrageenan, gum arabic, pectin, tragacanth, and cellulose ether, and 0.01 to 15 wt. % of an odor-reducing agent selected from at least one component of the group consisting of chloride and acid, wherein the abovementioned components always make up 100 wt. % respectively.

According to the invention, the term “cereal flour” is understood to refer to a mill middling flour or mill type flour from which the upper husk layers have been largely or almost completely removed by means of milling industry technology known to the person having ordinary skill in the art. Components of milling products of cereal are husking bran, bran, middlings, feed middlings, sprouted seeds, and the type flours. Whole grain flours are excluded here, as they are not subjected to any separating process. An example of the cereal flour used is type 2000 middlings. Type 2000 middlings are not ordinarily used for human consumption.

The cereal flour can be used in the form of a pregelatinized flour. Pregelatinized flour is an extruded flour, or also a chemically decomposed flour. In the extruder, a mixture of water and flour is uniformly pressed out of a shaping opening under high pressure and high temperature so that the starch in the pregelatinized flour is thermally decomposed in the extruding process. Because of this thermal decomposition or corresponding chemical starch decomposition processes, pregelatinized flours have a higher water-binding capacity than untreated flours. The pregelatinized flour can be produced from at least one cereal flour.

The cereal can be a gluten-free cereal or a gluten-containing cereal. For example, the gluten-free cereal flour is a flour that is at least one component of the group consisting of corn, rice, and millet.

The gluten-containing cereal flour can be a flour that is at least one component of the group consisting of wheat, spelt, rye, barley, or triticale. The use of rye flour and/or wheat flour is preferred, wherein the latter particularly preferably comprises protein enriched by protein shifting. The use of this gluten-containing cereal is advantageous, because the gluten in the cereal flour captures the undesired odor in the substance soaked with animal urine by forming a three-dimensional structure and does not allow it to escape into the surrounding air. However, odor binding can also be made possible by means of pentosans (gums), as is the case for rye, for example. Although rye is also a gluten-containing cereal, odor binding by pentosans is predominant.

If odor binding is not achieved by means of gluten or pentosans, it can be ensured by means of swelling starches. This applies in particular to gluten-free cereal flour.

The content of cereal flour is 65 to 99.5 wt. %, preferably 70 to 95 wt. %, and particularly preferably 75 to 94 wt. % of the litter. The amount to be used depends on the desired extent of the odor-binding effect and the clumping effect in the litter. The higher the cereal flour content of the litter, the more easily the urine-moistened upper components can be removed as sheet- or clod-shaped clumps, and the better the odor-binding capacity. The limit is determined by the desired quality and the desired price of the litter.

According to the invention, the litter consists of 0.1 to 20 wt. %, preferably 2 to 10 wt. %, and particularly preferably 3 to 5 wt. % of a gel-forming agent selected from at least one component of the group consisting of guar gum flour, locust bean flour, tara gum flour, xanthan, gellan, karaya, alginate, agar, carrageenan, gum arabic, pectin, tragacanth, and cellulose ether.

The cellulose ether in the present invention is not subject to any particular restrictions, and for example can be one of carboxymethyl cellulose, methyl cellulose, ethyl cellulose, hydroxyethyl cellulose, hydroxypropyl cellulose, methylethyl cellulose, hydroxyethyl methyl cellulose, and hydroxypropyl methyl cellulose.

The combination of cereal flour and the gel-forming agent allows the clump strength, liquid binding, odor reduction, lubricant film formation (i.e., seeping of the liquid to the bottom of the container filled with litter), and yield of the litter to be improved. However, a content of more than 20 wt. % of the gel-forming agent in the litter increases the stickiness of the litter to animal hairs.

The gel-forming agent is selected from at least one component of the group consisting of guar gum flour, locust bean flour, tara gum flour, xanthan, gellan, karaya, alginate, agar, carrageenan, gum arabic, pectin, tragacanth and cellulose ether. In particular, the use of gel-forming agents allows clump formation and stability to be improved, moisture absorption to be increased, and odor formation and decomposition processes of the ingredients of the litter to be prevented. Guar gum flour is preferred.

According to the invention, the litter consists of 0.01 to 15 wt. %, preferably 0.1 to 10 wt. %, and particularly preferably 1 to 6 wt. % of an odor-reducing agent selected from at least one component of the group consisting of chloride and acid.

According to the invention, the term “odor-reducing agent” is understood to refer to a substance that can bind and/or neutralize odor.

There are no particular restrictions on the chloride and the acid used in the present invention, provided that they can bind and/or neutralize odor. Preferably, the chloride is selected from at least one component of the group consisting of calcium chloride, magnesium chloride, and sodium chloride. According to a further preferred embodiment, the acid is selected from at least one component of the group consisting of ascorbic acid, tartaric acid, and citric acid. In addition to odor reduction, the chlorides have the advantageous function of allowing the bulk density of the litter to be decreased.

In an embodiment of the present invention, calcium chloride is used as an odor-reducing agent, wherein the content of calcium chloride in the litter is 1 to 10 wt. %, and preferably 3 to 5 wt. %.

According to a further embodiment, magnesium chloride is used as an odor-reducing agent, wherein the content of magnesium chloride is 1 to 10 wt. %, and preferably 4 to 8 wt. %. Magnesium chloride can be used for example in flake or powder form.

According to a further embodiment, citric acid is used as an odor-reducing agent, wherein the content of citric acid is 1 to 10 wt. %, and preferably 1 to 3 wt. %.

According to a further embodiment, ascorbic acid is used as an odor-reducing agent, with a content of 1 to 10 wt. %, and preferably 1 to 3 wt. %.

According to an embodiment, the odor-reducing agent is calcium chloride and/or citric acid. Both calcium chloride and citric acid allow highly favorable odor reduction that also lasts over a long period. Moreover, the use of calcium chloride allows the bulk density of the litter to be reduced in a particularly favorable manner.

In an embodiment, the litter consists of 90 to 94 wt. % of cereal flour, 3 to 5 wt. % of guar gum flour, and 3 to 5 wt. % of calcium chloride. Preferably, the litter consists of 92 wt. % of cereal flour, 4 wt. % of guar gum flour, and 4 wt. % of calcium chloride.

According to a further embodiment, the litter consists of 92 to 96 wt. % of cereal flour, 3 to 5 wt. % of guar gum flour, and 1 to 3 wt. % of citric acid. Preferably, the litter consists of 95 wt. % of cereal flour, 4 wt. % of guar gum flour, and 1 wt. % of citric acid.

According to the invention, the litter is in the form of pressed granules. Preferably, the pressed granules are virtually abrasion-proof. The term “abrasion-proof” used here means that as far as possible no particles detach from the granules formed in order to allow dust formation to be prevented. Pressed, abrasion-proof granules are advantageous because the litter does not become stuck to an animal's fur and therefore is not carried around in the residential area of the livestock farmer, which would occur in the case of powdered litter. The pressed, abrasion-proof granules can be obtained by the methods used in the prior art, e.g. as described in DE 37 32 807 A1.

The granules have a particle size of 0.1 to 10 mm, preferably 0.1 to 8 mm, and particularly 0.1 to 5 mm. The above-described characteristics of the granulate particles prevent the granulate particles from being dragged around by an animal and result in a free-flowing litter. In a laboratory test during the production process, the litter is sieved in a mesh size range of 0.1 to 1 mm in order to determine the content of particles having a size of less than 1 mm. The greater the number of particles having a size of less than 1 mm, the flatter the clumps formed during use, and the smaller the amount/height of product required for absorbing animal excretions. For example, if the content of particles having a particle size of between 0.1 and 1 mm is greater than 5%, the clump depth for 30 ml of test solution will be about 4 cm.

In an embodiment of the invention, more than 2% of the litter is held back by a sieve with a mesh size of 0.1 mm to 1 mm.

According to a preferred embodiment, the pressed granules consists of comminuted pressed pellets or a comminuted extrudate of the starting composition of the litter consisting of 65 to 99.5 wt. % of cereal flour, 0.1 to 20 wt. % of the abovementioned gel-forming agent, and 0.01 to 15 wt. % of the abovementioned odor-reducing agent that is pressed or extruded into pellets. By means of dry processing of the starting composition into pressed pellets or an extrudate, the starch of the cereal flour is damaged, which results in increased liquid absorption capacity of the litter. In particular, such a pressed cereal flour shows increased liquid absorption of up to 7 times its own weight, so that particularly effective liquid absorption can be achieved by means of this pressing.

The granules produced in this manner stick together on contact with a liquid, for example animal excretions, thus forming paste clumps within an extremely short period of time that harden within about 2 hours and can easily be removed approximately 1 minute after coming into contact with the liquid. The rapid paste formation is facilitated by the starch damage caused by pressing of the pellets or extrusion of the cereal flour.

According to an embodiment, each of the pellets has a diameter of 5 to 8 mm, preferably 5.5 to 7.5 mm, and a length of 10 to 15 mm, preferably 11 to 14 mm, and said pellets can be comminuted into the granulate particles after pressing by means of mechanical processing such as cutting, breaking, or crushing. The comminution can be followed by sifting in order to separate out excessively small and light components produced by comminution from the granules.

There are no particular restrictions on the shape of the extrudate. In the case of a rectangular cross-sectional opening of the extruder, the extrudate preferably has a respective width and height in a range of 1 to 8 mm, particularly preferably 2 to 7.5 mm, and any desired length. In use of a round cross-sectional opening, in contrast, the diameter of the extrudate is preferably 1.5 to 5 mm, and particularly preferably 2 to 4 mm. The extrudate can then be comminuted into the granulate particles by means of mechanical processing such as cutting, breaking, or crushing. The comminution can be followed by sifting in order to separate out excessively small and light components produced by comminution from the granules.

According to a further embodiment, the bulk density of the litter is 200 to 800 g/l, preferably 250 to 750 g/l, and particularly preferably 450 to 550 g/l. By using chlorides, in particular calcium chloride, the bulk density can be reduced. By adding calcium chloride, for example, the bulk density of a litter consisting of cereal and gel-forming agents can be reduced from 570 g/l to 530 g/l.

A second aspect of the present invention relates to the use of the above-defined litter for absorbing animal excretions. According to a preferred embodiment, the litter is used for absorbing animal urine. There are no particular restrictions on the type of animal in this case. According to a preferred embodiment, the animal is a cat.

A third aspect of the present invention relates to a method for producing the litter comprising the following steps in the order below:
(a) provision of a starting composition, consisting of 65 to 99.5 wt. % of cereal flour, 0.1 to 20 wt. % of a gel-forming agent selected from at least one component of the group consisting of guar gum flour, locust bean flour, tara gum flour, xanthan, gellan, karaya, alginate, agar, carrageenan, gum arabic, pectin, tragacanth and cellulose ether, and 0.01 to 15 wt. % of an odor-reducing agent selected from at least one component of the group consisting of chloride and acid, wherein the abovementioned components always make up 100 wt. % respectively,
(b) pelleting or extruding of the starting composition of step (a), and
(c) comminuting of the pellets or the extrudate of step (b).

The cereal flour, the gel-forming agent, and the odor-reducing agent used in the method correspond to the cereal flour, the gel-forming agent, and the odor-reducing agent of the above-defined litter. Moreover, the pellets or the extrudate of the method have the abovementioned properties of the pellets or the extrudate of the litter and can be obtained by means of the above-described method.

According to an embodiment of the method according to the invention, a step (d) of sifting can be carried out after step (c), wherein excessively small and light components produced by comminution can be separated out from the granules.

The litter for use in animal husbandry according to the invention is advantageous in that it allows clump formation with high clump strength, causes little sticking to animal hairs, and moreover shows a strong odor-binding action.

The figures are as follows:

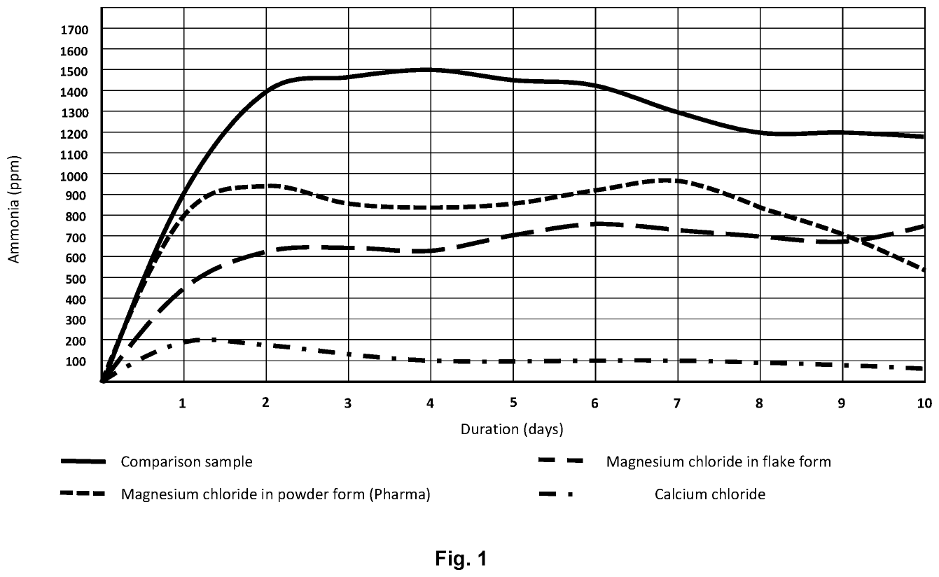

FIG. 1 shows the ammonia production of various litters (“comparison sample,” “magnesium chloride in powder form (Pharma),” “magnesium chloride in flake form” and “calcium chloride”).

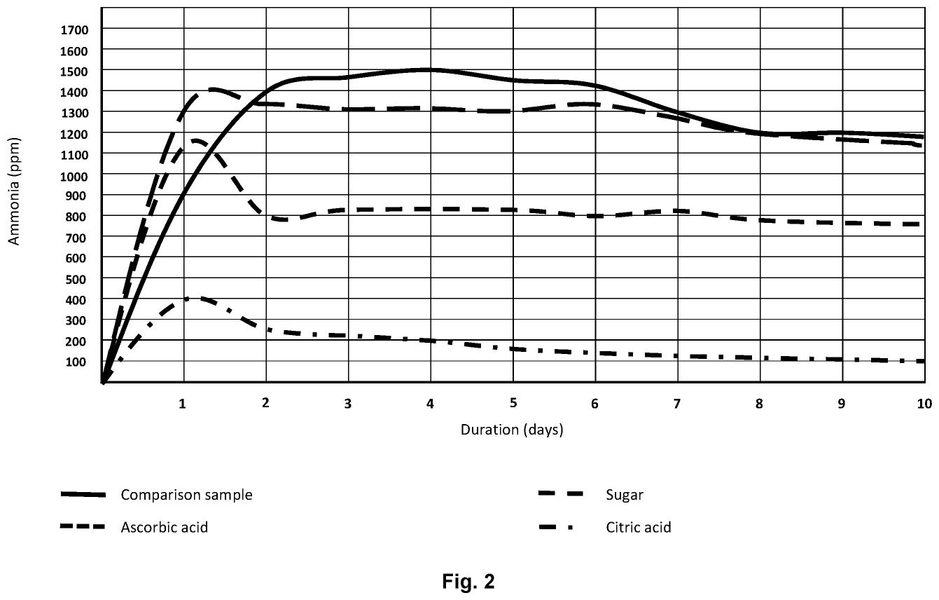

FIG. 2 shows the ammonia production of various litters (“comparison sample,” “ascorbic acid,” “sugar” and “citric acid”).

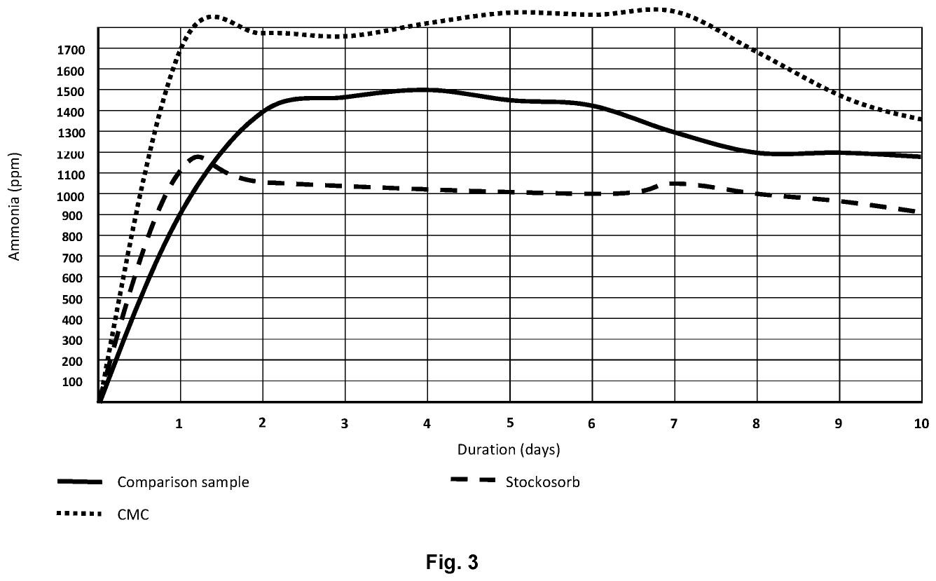

FIG. 3 shows the ammonia production of various litters (“comparison sample,” “CMC” and “Stockosorb”).

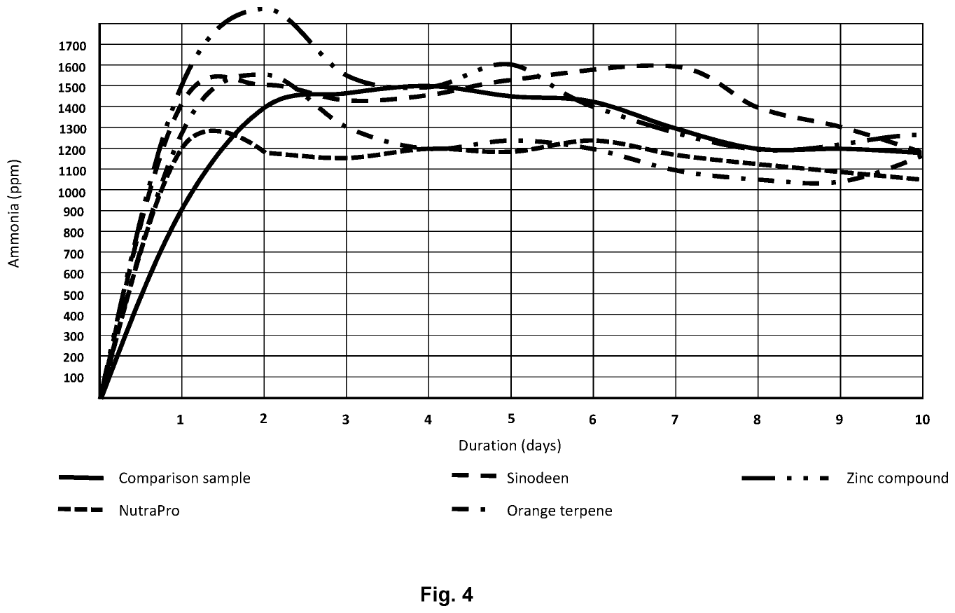

FIG. 4 shows the ammonia production of various litters (“comparison sample,” “NutraPro,” “Sinodeen,” “orange terpene” and “zinc compound”).

The following examples serve to further explain the present invention, but it is not limited thereto.

Litters of various compositions (given in wt. %) were saturated with urine, after which the ammonia gas content of the individual litters was measured over time.

The following litters were used:

“Comparison sample” (cf. FIGS. 1 to 4):
4% guar gum flour
96% wheat flour

FIG. 1:

“Magnesium chloride in powder form (Pharma)”:
4% guar gum flour
4% magnesium chloride; powder form (pharmaceutical quality)
92% wheat flour

“Magnesium chloride in flake form”:
4% guar gum flour
4% magnesium chloride in flake form
92% wheat flour

“Calcium chloride”:
4% guar gum flour
4% calcium chloride; powder form (pharmaceutical quality)
92% wheat flour

FIG. 2:

“Ascorbic acid”:
1% ascorbic acid
4% guar gum flour
95% wheat flour

“Sugar”:
4% guar gum flour
4% sugar
92% wheat flour

“Citric acid”:
1% citric acid
4% guar gum flour
95% wheat flour

FIG. 3:

“CMC”:
4% guar gum flour
4% carboxymethyl cellulose 75aH/P50 from the firm Mikro-Technik
92% wheat flour

“Stockosorb”:
4% guar gum flour
1% Stockosorb® from Evonik
95% wheat flour

FIG. 4:

“NutraPro”:
4% guar gum flour
0.6% NutraPro® (mixture of bacteria); dissolved in water (0.6% solid material calculated in the product), sprayed on the final product of guar gum flour and wheat flour
95.4% wheat flour

“Sinodeen”:
4% guar gum flour
2% Sinodeen® from the firm Sinodeen; sprayed on the final product of guar gum flour and wheat flour
94% wheat flour

“Orange terpene”:
4% guar gum flour
0.2% orange terpene; sprayed on the final product of guar gum flour and wheat flour
95.8% wheat flour

“Zinc compound”:
4% guar gum flour
0.2% zinc compound of FRANCHEM® Sorb from the firm FrankenCHEMIE, sprayed on the final product of guar gum flour and wheat flour
95.8% wheat flour

It can be clearly seen from FIGS. 1 to 4 that the litter according to the invention has an outstanding odor-binding action. The “citric acid” and “calcium chloride” litters show extremely low ammonia gas content throughout the duration of the test. Moreover, the litters containing magnesium chloride in flake or powder form and the litter with ascorbic acid show a significantly lower ammonia gas content than the comparison examples. Because of the only minimal ammonia production of the litters according to the invention, it is only necessary to use small amounts of the litter in order to achieve favorable odor binding.

1. A litter for use in animal husbandry in the form of pressed granules having a particle size of 0.1 to 10 mm, consisting of
65 to 99.5 wt. % of cereal flour,
0.1 to 20 wt. % of a gel-forming agent selected from at least one component of the group consisting of guar gum flour, locust bean flour, tara gum flour, xanthan, gellan, karaya, alginate, agar, carrageenan, gum arabic, pectin, tragacanth and cellulose ether, and
0.01 to 15 wt. % of an odor-reducing agent selected from at least one component of the group consisting of chloride and acid,
wherein the abovementioned components always make up 100 wt. % respectively.

2. The litter as claimed in claim 1, wherein the chloride is selected from at least one component of the group consisting of calcium chloride, magnesium chloride and sodium chloride.

3. The litter as claimed in claim 1, wherein the acid is selected from at least one component of the group consisting of ascorbic acid, tartaric acid and citric acid.

4. The litter as claimed in claim 1, wherein the content of the gel-forming agent is 3 to 5 wt. %.

5. The litter as claimed in claim 1, wherein the gel-forming agent is guar gum flour.

6. The litter as claimed in claim 1, wherein the content of the odor-reducing agent is 1 to 6 wt. %.

7. The litter as claimed in claim 1, wherein the odor-reducing agent is calcium chloride and/or citric acid.

8. The litter as claimed in claim 7, wherein the content of calcium chloride is 3 to 5 wt. %.

9. The litter as claimed in claim 7, wherein the content of citric acid is 1 to 3 wt. %.

10. The litter as claimed in claim 1, wherein the litter is consisting of 90 to 94 wt. % of cereal flour, 3 to 5 wt. % of guar gum flour, and 3 to 5 wt. % of calcium chloride.

11. The litter as claimed in claim 1, wherein the litter is consisting of 92 to 96 wt. % of cereal flour, 3 to 5 wt. % of guar gum flour, and 1 to 3 wt. % of citric acid.

12. The litter as claimed in claim 1, wherein the cereal flour is at least one component of the group consisting of wheat, spelt, rye, barley, or triticale.

13. The litter as claimed in claim 1, wherein more than 2% of the litter is held back by a sieve with a mesh size of 0.1 mm to 1 mm.

14. A method of absorbing animal excretions comprising contacting the litter as claimed in claim 1 with an animal excretion.

15. A method for producing a litter as claimed in claim 1, comprising the following steps in the order below:
(a) provision of a starting composition, consisting of
65 to 99.5 wt. % of cereal flour,
0.1 to 20 wt. % of a gel-forming agent selected from at least one component of the group consisting of guar gum flour, locust bean flour, tara gum flour, xanthan, gellan, karaya, alginate, agar, carrageenan, gum arabic, pectin, tragacanth and cellulose ether, and
0.01 to 15 wt. % of an odor-reducing agent selected from at least one component of the group consisting of chloride and acid,
wherein the abovementioned components always make up 100 wt. % respectively,
(b) pelleting or extruding of the starting composition of step (a), and
(c) comminuting of the pellets or the extrudate of step (b).
